(19) United States
(12) Patent Application Publication
(10) Pub. No.: US 2002/0047809 A1
(43) Pub. Date: Apr. 25, 2002

(54) GPS RECEIVING ANTENNA WITH ENSURED MAGNET ATTRACTION AND FIRM MOUNTING OF ANTENNA BODY

(75) Inventors: Tomoki Ikeda, Fukushima-ken (JP); Tadaaki Onishi, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/837,692

(22) Filed: Apr. 18, 2001

(30) Foreign Application Priority Data
Apr. 20, 2000 (JP) 2000-126241

(51) Int. Cl. H01Q 1/32; H01Q 1/00; H01Q 1/42

(52) U.S. Cl. 343/713; 343/872; 343/700 MS

(57) ABSTRACT

A GPS receiving antenna is disclosed wherein a hole for communication between a recess portion and a receptacle portion is formed in a bottom wall with the recess portion formed therein and an adhesive is applied into the hole to bond an antenna body and a magnet with each other. Therefore, the adhesive does not protrude to the exterior of the recess portion, so that the appearance of the GPS receiving antenna is improved and a surface attraction of the magnet is ensured, thus ensuring a more positive mounting of the antenna than in the prior art.

### BACKGROUND OF THE INVENTION

1. Field of the Invention

The present invention relates to a GPS receiving antenna attached to the outside of a moving object such as a ship or an automobile to receive a radio wave generated from a GPS (Global Positioning System) satellite.

2. Description of the Prior Art

The configuration of a conventional GPS receiving antenna will now be described with reference to FIGS. 4 and 5. A box-shaped upper case 21, which is formed by molding a synthetic resin, comprises an upper wall 21a, side walls 21b extending from four sides of the upper wall 21a, a receptacle portion 21c surrounded by the upper wall 21a and side walls 21b and whose underside is open, and stepped portions 21d formed as recesses in and along the side walls 21b.

A box-shaped lower case 22, which is formed by molding a synthetic resin, comprises a bottom wall 22a, side walls 22b extending from four sides of the bottom wall 22a, a receptacle portion 22c surrounded by the bottom wall 22a and side walls 22b and whose upper side is open, stepped portions 22d formed as projections in and along the side walls 22b, and a pair of recess portions 22e each formed in the shape of a rectangular parallelepiped in the underside of the bottom wall 22a.

The upper and lower cases 21, 22 are combined together so that the receptacle portions 21c and 22c are opposed to each other and are mounted together by a suitable means.

As a result, a single receptacle portion is formed by the receptacle portions 21c and 22c and the stepped portions 21d and 22d are fitted together, with a packing being mounted in each of the thus-fitted portion to seal the interiors of the receptacle portions 21c and 22c. Thus, there is provided a waterproof configuration against the entry of water, etc.

An antenna body 24 is made up of: an earth plate 25; an antenna element 26 for receiving a radio wave from a GPS satellite, the antenna element 26 being provided on the surface side of the earth plate 25; a dielectric substrate 27 provided on the back side of the earth plate 25, with electric components (not shown) such as resistors, capacitors and IC parts being mounted on the substrate 27; and a shielding case 28 for shielding the dielectric substrate 27 electrically.

The antenna body 24 thus constructed is accommodated within the sealed receptacle portions 21c and 22c in such a manner that the shielding case 28 lies on the bottom wall 22a side of the lower case 22.

A waterproofing sleeve 30 is fitted on an outer surface of a coaxial cable 29 and the coaxial cable 29 is mounted in a state such that the sleeve 30 is sandwiched between the upper and lower cases 21, 22. The coaxial cable 29 is connected to the dielectric substrate 27 and is drawn out to the exterior.

A pair of magnets 31, each in the shape of a rectangular parallelepiped, are received respectively within the recess portions 22e of the lower case 22 and are attached to the lower case 22 with an adhesive 32 applied into the recess portions 22e.

By utilizing the magnetism of the magnets 31, the GPS receiving antenna thus constructed is attached by attraction to the outside of a moving object such as a ship or an automobile (the roof of an automobile, for example).

In the conventional GPS receiving antenna, since the adhesive 32 for mounting the magnets 31 is applied into the recess portions 22e of the lower case 22, the adhesive 32 applied to upper surfaces of the recess portions 22e is forced out to the exterior of the recess portions 22e by being pushed with the magnets 31, thus giving rise to the problem that not only the commercial value is impaired but also surface-attraction of the magnets 31 is obstructed by the thus-protruded adhesive 32, resulting in the mounting of the GPS receiving antenna becoming unstable.

Moreover, since the antenna body 24 is merely accommodated within the receptacle portions 21c and 22c, the mounting thereof is unstable and there occurs wobbling.

### SUMMARY OF THE INVENTION

Accordingly, it is an object of the present invention to provide a GPS receiving antenna free of adhesive protrusion, capable of ensuring magnet attraction, and with an antenna body mounted firmly.

For achieving the above-mentioned object, according to the first means adopted by the present invention, there is provided a GPS receiving antenna comprising upper and lower cases; an antenna body received in a receptacle portion formed by the upper and lower cases; and a magnet received in a recess portion formed in a lower surface of a bottom wall of the lower case and bonded to the lower case with an adhesive, wherein a hole for communication between the recess portion and the receptacle portion is formed in the bottom wall in which the recess portion is formed, and the adhesive is applied into the hole to bond the antenna body and the magnet with each other.

According to the second means adopted by the present invention there is provided, in combination with the above first means, a GPS receiving antenna wherein a depression is formed in the lower surface of the bottom wall opposed to the magnet so that the adhesive is present in the depression.

### BRIEF DESCRIPTION OF THE DRAWINGS

FIG. 1 is a sectional view of a principal portion of GPS receiving antenna according to the first embodiment of the present invention;

FIG. 2 is a bottom view thereof,

FIG. 3 is a sectional view of a principal portion of a GPS receiving antenna according to the second embodiment of the present invention;

FIG. 4 is a sectional view of a principal portion of a conventional GPS receiving antenna; and

FIG. 5 is a bottom view thereof.

### DETAILED DESCRIPTION OF PREFERRED EMBODIMENTS

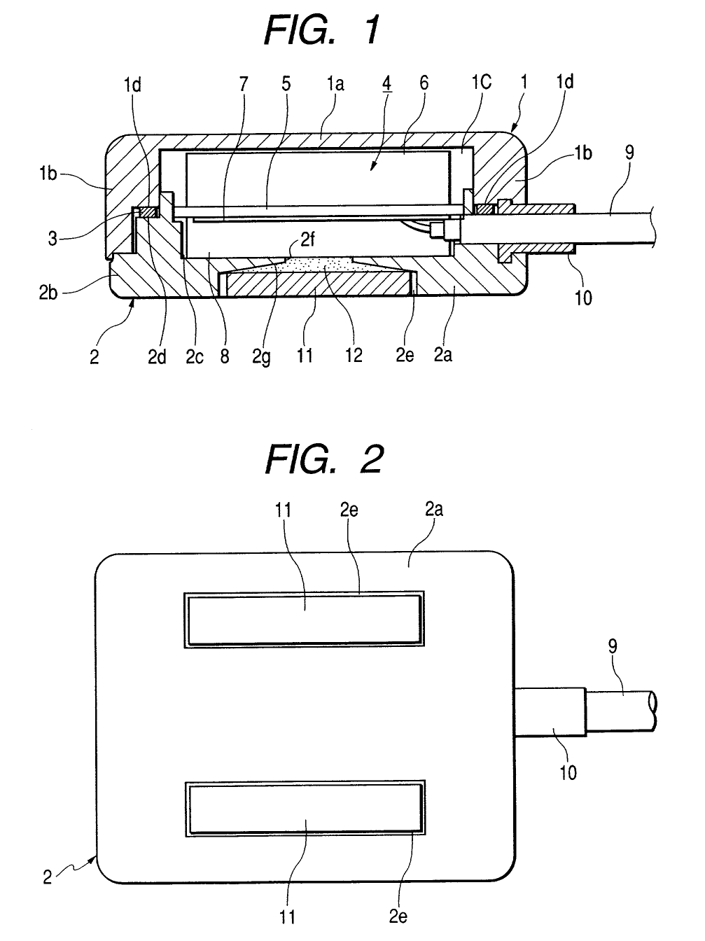

A GPS receiving antenna according to the first embodiment of the present invention will be described below with reference to FIGS. 1 and 2.

An upper case 1, which is formed in a box shape by molding a synthetic resin, comprises an upper wall 1a, side walls 1b extending from four sides of the upper wall 1a, a receptacle portion 1c surrounded by the upper wall 1a and the side walls 1b and whose underside is open, and stepped portions 1d formed as recesses in and along the side walls 1b.

A lower case 2, which is formed in a box shape by molding a synthetic resin, comprises a bottom wall 2a, side walls 2b extending from four sides of the bottom wall 2a, a receptacle portion 2c surrounded by the bottom wall 2a and the side walls 2b and whose upper side is open, stepped portions 2d formed as projections in and along the side walls 2b, a pair of recess portions 2e each formed in the shape of a rectangular parallelepiped in a lower surface of the bottom wall 2a, holes 2f formed in the bottom wall 2a to provide communication between the receptacle portion 2c and the recess portions 2e, and depressions 2g formed respectively in upper surfaces of the recess portions 2e. The upper and lower cases 1, 2 are combined so that the receptacle portions 1c and 2c are opposed to each other, and are mounted together by a suitable means.

At this time, a single receptacle portion is formed by the receptacle portions 1c and 2c and the stepped portions 1d and 2d are fitted together. A packing 3 is disposed in the thus-fitted portion to seal the interiors of the receptacle portions 1c and 2c. In this way there is provided a waterproof structure against the entry of water, etc.

An antenna body 4 is made up of an earth plate 5, an antenna element 6 provided on the surface side of the earth plate 5 to receive a radio wave from a GPS satellite, a dielectric substrate 7 disposed on the back side of the earth plate 5 and with electric components (not shown) such as resistors, capacitors and IC parts mounted thereon, and a shielding case 8 for shielding the dielectric substrate 7 electrically.

The antenna body 4 is received within the sealed receptacle portions 1c and 2c in such a manner that the shield case 8 lies on the bottom wall 2a side of the lower case 2.

A waterproofing sleeve 10 is fitted on an outer surface of a coaxial cable 9. The coaxial cable 9 is mounted in a sandwiched state of the sleeve 10 between the upper and lower cases 1, 2 and it is connected to the dielectric substrate 7 and is drawn out to the exterior.

A pair of magnets 11 each in the shape of a rectangular parallelepiped are received respectively within the recess portions 2e of the lower case 2 and an adhesive 12 is applied into the depressions 2g and holes 2f formed in the recess portions 2e. With the adhesive 12, the magnets 11 and the shield case 8 as the antenna body 4 are bonded together and secured to the lower case 2.

In this case, since the adhesive 12 is present in the depressions 2g, the magnets 11 are bonded more firmly to the lower case 2.

Although in this first embodiment the depressions 2g are formed in an inclined state, the depressions 2g may be formed with a stepped portion as a substituted for such an inclined portion.

By utilizing the magnetism of the magnets 11 the GPS receiving antenna constructed as above is attached attractively to the outside of a moving object such as a ship or an automobile (the roof of an automobile, for example).

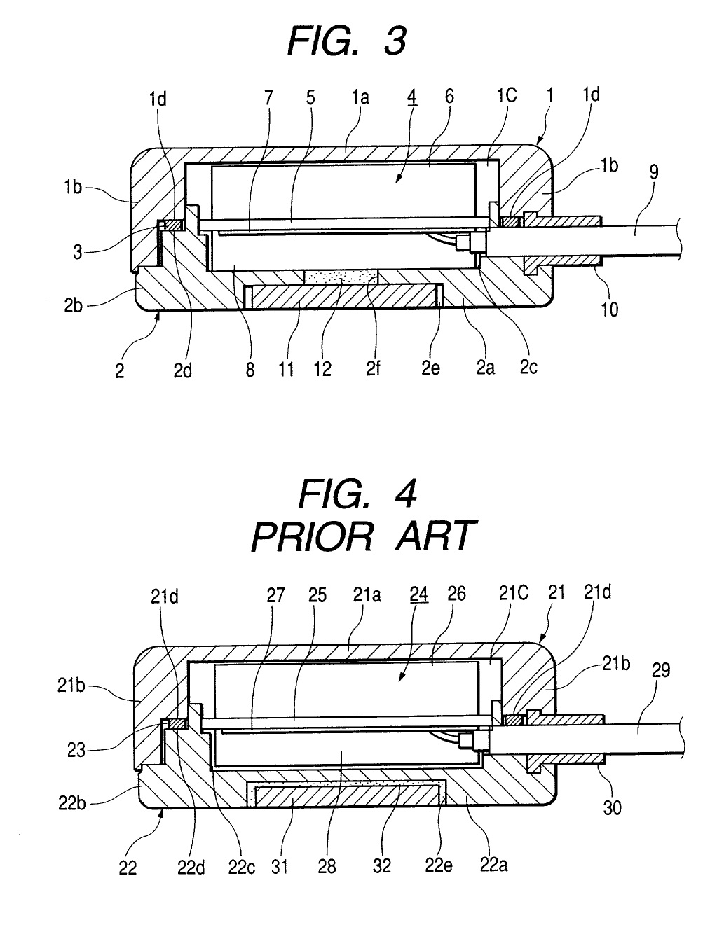

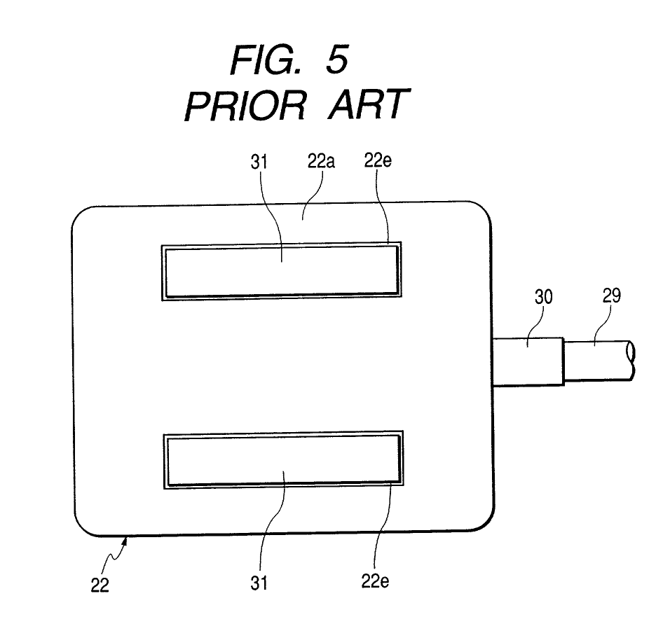

Referring now to FIG. 3, there is illustrated a GPS receiving antenna according to the second embodiment of the present invention, in which the depressions 2g used in the previous first embodiment are not formed, but only holes 2f are formed. Other components in this second embodiment are the same as in the first embodiment, so will be identified by the same reference numerals as in the first embodiment and explanations thereof will here be omitted.

In the GPS receiving antenna according to the present invention, as set forth above, since holes 2f for communication between the recess portions 2e and the receptacle portion 2c are formed in the bottom wall 2a which defines the recess portions 2e and the antenna body 4 and the magnet 11 are bonded together through an adhesive applied into the holes 2f, the adhesive 12 does not protrude to the exterior of the recess portions 2e. Consequently, the appearance of the GPS receiving antenna is improved and a surface attraction of the magnets 11 is ensured, thus ensuring a more positive mounting of the antenna than in the prior art.

Further, since the depressions 2g are formed in the lower surface of the bottom wall 2g opposed to the magnets 11 and the adhesive 12 is present in the depressions 2g, the magnets 11 can be bonded to the case 2 more firmly.

What is claimed is:

1. A GPS receiving antenna comprising:
an upper case and a lower case;
an antenna body received in a receptacle portion formed by the upper and lower cases; and
a magnet received in a recess portion formed in a lower surface of a bottom wall of the lower case and bonded to the lower case with an adhesive,
wherein a hole for communication between the recess portion and the receptacle portion is formed in the bottom wall in which the recess portion is formed, and the adhesive is applied into the hole to bond the antenna body and the magnet with each other.

2. A GPS receiving antenna according to claim 1, wherein a depression is formed in the lower surface of the bottom wall opposed to the magnet so that the adhesive is present in the depression.
